(19) United States
(12) Patent Application Publication
(10) Pub. No.: US 2020/0374649 A1
(43) Pub. Date: Nov. 26, 2020

(54) DEVICE AND METHOD OF OBJECT-BASED SPATIAL AUDIO MASTERING

(71) Applicant: Fraunhofer-Gesellschaft zur Förderung der angewandten Forschung e.V., Munich (DE)

(72) Inventors: Simon HESTERMANN, Ilmenau (DE); Christoph SLADECZEK, Ilmenau (DE); Mario SEIDENECK, Ilmenau (DE)

(21) Appl. No.: 16/990,835

(22) Filed: Aug. 11, 2020

Related U.S. Application Data
(63) Continuation of application No. PCT/EP2019/053961, filed on Feb. 18, 2019.

(30) Foreign Application Priority Data
Feb. 19, 2018 (DE) 102018202511.8
Apr. 19, 2018 (DE) 102018206025.8

(51) Int. Cl. H04S 7/00; H04R 3/04; H04R 5/04; G10L 19/00

(52) U.S. Cl. CPC H04S 7/307; H04R 3/04; H04S 2400/03; G10L 19/00; H04S 2400/11; H04R 5/04

(57) ABSTRACT

A device for generating a processed signal while using a plurality of audio objects in accordance with an embodiment includes: an interface for specification of at least one effect parameter of a processing-object group of audio objects on the part of a user, wherein the processing-object group of audio objects includes two or more audio objects of the plurality of audio objects. The device further includes a processor unit configured to generate the processed signal such that the at least one effect parameter specified by means of the interface is applied to the audio object signal or to the audio object metadata of each of the audio objects of the processing-object group of audio objects. One or more audio objects of the plurality of audio objects do not belong to the processing-object group of audio objects.

### CROSS-REFERENCES TO RELATED APPLICATIONS

This application is a continuation of copending International Application No. PCT/EP2019/053961, filed Feb. 18, 2019, which is incorporated herein by reference in its entirety, and additionally claims priority from German Applications Nos. DE 10 2018 202 511.8, filed Feb. 19, 2018, and DE 102018206025.8, filed Apr. 19, 2018, both of which are incorporated herein by reference in their entirety.

The application concerns audio object processing, audio object encoding and decoding and, in particular, audio mastering for audio objects.

### BACKGROUND OF THE INVENTION

Object-based spatial audio is an approach to interactive three-dimensional audio re-production. This concept not only changes the way content creators or authors may interact with audio, but also how audio is stored and transmitted. To make this possible, a new process in the reproduction chain, referred to as “rendering”, may be established. The rendering process generates loudspeaker signals from an object-based scene description. Although research into recording and mixing has been done in recent years, concepts for object-based mastering are almost non-existent. The main difference compared to channel-based audio mastering is that instead of adjusting the audio channels, the audio objects may be modified. This involves a fundamentally new approach to mastering. In this paper, a new method of mastering object-based audio is presented.

In recent years, the object-based audio approach has aroused much interest. In comparison to channel-based audio, where loudspeaker signals are stored as a result of spatial audio production, the audio scene is described by audio objects. An audio object may be regarded as a virtual sound source consisting of an audio signal with additional metadata such as position and gain. To reproduce audio objects, a so-called audio renderer may be used. Audio rendering is the process of generating loudspeaker or headphone signals on the basis of additional information, such as the position of loudspeakers or the position of the listener in the virtual scene.

The process of audio content creation may be divided into three main parts: recording, mixing and mastering. While all three steps have been extensively covered for channel-based audio over the past decades, object-based audio will involve new workflows for future applications. In general, the recording step does not yet need to be changed, even though future technologies might bring new possibilities [1], [2]. For the mixing process, the situation is somewhat different as the sound engineer no longer creates a spatial mix by panning signals to dedicated speakers. Instead, all positions of audio objects are created by a spatial authoring tool that allows defining of the metadata part of each audio object. A complete mastering process for audio objects has not yet been established [3].

Conventional audio mixes route multiple audio tracks to a certain number of output channels. This involves creating individual mixes for different reproduction (playback) configurations, but allows efficient handling of the output channels during mastering [4]. When using the object-based audio approach, the audio renderer is responsible for creating all speaker signals in real time. Arranging a large number of audio objects within the framework of a creative mixing process leads to complex audio scenes. However, since the renderer may reproduce the audio scene in several different loudspeaker means, it is not possible to address the output channels directly during production. The mastering concept may therefore be based only on modifying audio objects individually.

Until today, conventional audio production is still directed at very specific listening facilities and their channel configurations, for example stereo or surround reproduction. The decision stating the reproduction device(s) for which the content is configured may therefore be made at the beginning of its production. The production process itself then consists of recording, mixing and mastering. The mastering process optimizes the final mix to ensure that the mix is reproduced in a satisfactory quality on all consumer systems with different speaker characteristics. Since the desired output format of a mix is fixed, the mastering engineer (ME) may create an optimized master for this reproduction configuration.

The mastering phase makes it useful for creators to produce audio in suboptimal acoustic environments, as they can rely on a final check of their mix during mastering. This lowers the access barriers for producing professional content. On the other hand, the MEs themselves have been offered a wide range of mastering tools over the years, which has dramatically improved their ability to make corrections and enhancements. Nevertheless, the final content is usually limited to the reproduction means for which it was configured.

This limitation is generally overcome by Object-Based Spatial Audio Production (OBAP). In contrast to channel-based audio, OBAP is based on individual audio objects with metadata that encompasses their position in an artificial environment also referred to as a “scene”. Only at the final listening output, a dedicated rendering unit, the renderer, computes the final speaker signals in real time on the basis of the speaker means of the listener.

Although OBAP provides each audio object and its metadata to the renderer individually, no direct channel-based adjustments are possible during production, and therefore, no existing mastering tools for conventional reproduction equipment may be used. Meanwhile, OBAP involves that all final adjustments are made in the mix. While the requirement to implement overall sound adjustments by manually handling each individual audio object is not only highly inefficient, this circumstance also places high demands on the monitoring equipment of each creator and limits the sound quality of object-based 3D audio content strictly to the acoustic properties of the environment in which it was created.

Ultimately, developing tools to enable a similarly powerful mastering process for OBAP on the creator side might improve acceptance of 3D audio content production by lowering production barriers and opening up new space for sound aesthetics and quality.

While initial thoughts on spatial mastering have been made available to the public [5], this paper presents new approaches to how traditional mastering tools may be adapted and what types of new tools may be considered helpful in mastering object-based spatial audio. Thus, [5] describes a basic sequence of how metadata may be used to derive object-specific parameters from global properties. Furthermore, [6] describes a concept of a area of interest with a surrounding transition region in the context of OBAP applications.

It is therefore desirable to provide improved object-based audio mastering concepts.

### SUMMARY

According to an embodiment, a device for generating a processed signal while using a plurality of audio objects, each audio object of the plurality of audio objects including an audio object signal and audio object metadata, the audio object metadata including a position of the audio object and a gain parameter of the audio object, may have: an interface for specification of at least one effect parameter of a processing-object group of audio objects on the part of a user, the processing-object group of audio objects including two or more audio objects of the plurality of audio objects, and a processor unit configured to generate the processed signal such that the at least one effect parameter specified by means of the interface is applied to the audio object signal or to the audio object metadata of each of the audio objects of the processing-object group of audio objects.

According to another embodiment, a system may have: an encoder for generating a downmix signal on the basis of audio object signals of a plurality of audio objects and for generating a metadata signal on the basis of audio object metadata of the plurality of audio objects, wherein the audio object metadata includes a position of the audio object and a gain parameter of the audio object, and a decoder for generating an audio output signal including one or more audio output channels on the basis of the downmix signal and on the basis of the metadata signal, wherein the encoder is an inventive device, or wherein the decoder is an inventive device, or wherein the encoder is an inventive device and the decoder is an inventive device.

According to another embodiment, a method of generating a processed signal while using a plurality of audio objects, each audio object of the plurality of audio objects including an audio object signal and audio object metadata, the audio object metadata including a position of the audio object and a gain parameter of the audio object may have the steps of: specifying at least one effect parameter of a processing-object group of audio objects on the part of a user by means of an interface, wherein the processing-object group of audio objects includes two or more audio objects of the plurality of audio objects, and generating the processed signal by a processor unit such that the at least one effect parameter specified by means of the interface is applied to the audio object signal or to the audio object metadata of each of the audio objects of the processing-object group of audio objects.

According to yet another embodiment, a non-transitory digital storage medium may have a computer program stored thereon to perform the inventive method, when said computer program is run by a computer.

A device for generating a processed signal while using a plurality of audio objects in accordance with an embodiment is provided, wherein each audio object of the plurality of audio objects comprises an audio object signal and audio object metadata, wherein the audio object metadata includes a position of the audio object and a gain parameter of the audio object. The device comprises: an interface for specification of at least one effect parameter of a processing-object group of audio objects on the part of a user, wherein the processing-object group of audio objects comprises two or more audio objects of the plurality of audio objects. The device further comprises a processor unit configured to generate the processed signal such that the at least one effect parameter specified by means of the interface is applied to the audio object signal or to the audio object metadata of each of the audio objects of the processing-object group of audio objects. One or more audio objects of the plurality of audio objects do not belong to the processing-object group of audio objects.

A method of generating a processed signal while using a plurality of audio objects is further provided, wherein each audio object of the plurality of audio objects comprises an audio object signal and audio object metadata, the audio object metadata including a position of the audio object and a gain parameter of the audio object. The method comprises:
specifying at least one effect parameter of a processing-object group of audio objects on the part of a user by means of an interface (110), wherein the processing-object group of audio objects comprises two or more audio objects of the plurality of audio objects. And:
generating the processed signal by a processor unit (120) such that the at least one effect parameter specified by means of the interface is applied to the audio object signal or to the audio object metadata of each of the audio objects of the processing-object group of audio objects.

Furthermore, a computer program containing a program code for performing the above described method is provided.

The audio mastering provided is based on mastering of audio objects. In embodiments, these may be freely positioned at any position and in real-time in a scene. In embodiments, the properties of general audio objects, for example, are influenced. In their function as artificial containers, they may each contain an arbitrary number of audio objects. Each adjustment to a mastering object is transformed into individual adjustments to audio objects thereof in real time.

Such mastering objects are also referred to as processing objects.

Thus, instead of having to make separate adjustments to numerous audio objects, the user may use a mastering object to make mutual adjustments to several audio objects simultaneously.

For example, the set of target audio objects for a mastering object may be defined in numerous ways, in accordance with embodiments. From a spatial perspective, the user may define a customized range of validity around the mastering object's location. Alternatively, it is possible to link individually selected audio objects to the mastering object regardless of their position. The mastering object also considers potential changes in the position of audio objects over time.

A second property of mastering objects according to embodiments may be, for example, their ability to calculate, on the basis of interaction models, how each audio object is individually influenced. Similar to a channel strip, a mastering object may take over any general mastering effect, such as equalizers and compressors. Effect plug-ins usually provide the user with numerous parameters, e.g. for frequency or gain control. When a new mastering effect is added to a mastering object, it is automatically copied into all audio objects in the target set of said mastering object. However, not all effect parameter values are transferred unchanged. Depending on the calculation method for the target set, some mastering effect parameters may be weighted before being applied to a specific audio object. Weighting may be based on any metadata or on a sound characteristic of the audio object.

### BRIEF DESCRIPTION OF THE DRAWINGS

Embodiments of the present invention will be detailed subsequently referring to the appended drawings, in which:

FIG. 1 shows a device for generating a processed signal while using a plurality of audio objects in accordance with one embodiment.

FIG. 2 shows a device in accordance with another embodiment, the device being an encoder.

FIG. 3 shows a device in accordance with another embodiment, the device being a decoder.

FIG. 4 shows a system in accordance with one embodiment.

FIG. 5 shows a processing object comprising the area A and the fading area A_{f} in accordance with one embodiment.

FIG. 6 shows a processing object comprising the area A and object radii in accordance with an embodiment.

FIG. 7 shows a relative angle of audio objects to the processing object in accordance with an embodiment.

FIG. 8 shows an equalizer object with a new radial circumference in accordance with an embodiment.

FIG. 9 shows a signal flow of a compression of signals from n sources in accordance with an embodiment.

FIG. 10 shows a scene transformation while using a control panel M in accordance with an embodiment.

FIG. 11 shows the context of a processing object that causes audio signal effects and metadata effects in accordance with an embodiment.

FIG. 12 shows the modification of audio objects and audio signals upon a user input in accordance with an embodiment.

FIG. 13 shows a processing object PO₄ with a rectangle M for distortion of corners C₁, C₂, C₃ and C₄ by the user in accordance with an embodiment.

FIG. 14 shows the processing objects PO₁ and PO₂ with their respective overlapping two-dimensional zones of influence A and B in accordance with an embodiment.

FIG. 15 shows the processing object PO₃ with a rectangular, two-dimensional zone of influence C and the angles between PO₃ and the assigned sources S₁, S₂ and S₃ in accordance with an embodiment.

FIG. 16 shows a possible schematic implementation of an equalizer effect applied to a processing object in accordance with an embodiment.

FIG. 17 shows the processing object PO₅ with a three-dimensional zone of influence D and the respective distances d_{S}_{₁}, d_{S}_{₂} and d_{S}_{₃} to the sources S₁, S₂ and S₃ assigned via the zone of influence in accordance with an embodiment.

FIG. 18 shows a prototypical implementation of a processing object to which an equalizer was applied, in accordance with an embodiment.

FIG. 19 shows a processing object as in FIG. 18, but in a different position and without a transition area in accordance with an embodiment.

FIG. 20 shows a processing object with an area defined as a zone of influence via its azimuth, so that the sources Src22 and Src4 are associated with the processing object, in accordance with an embodiment.

FIG. 21 shows a processing object as in FIG. 20, but with an additional transition area that may be controlled by the user via the “Feather” slider, in accordance with an embodiment.

FIG. 22 shows several processing objects in the scene, with different zones of influence, in accordance with an embodiment.

FIG. 23 shows the red square on the right side of the image shows a processing object for horizontal distortion of the position of audio objects in accordance with an embodiment.

FIG. 24 shows the scene after the user has distorted the corners of the processing object. The position of all sources has changed as a function of the distortion, in accordance with an embodiment.

FIG. 25 shows a possible visualization of the association of individual audio objects with a processing object in accordance with an embodiment.

### DETAILED DESCRIPTION OF THE INVENTION

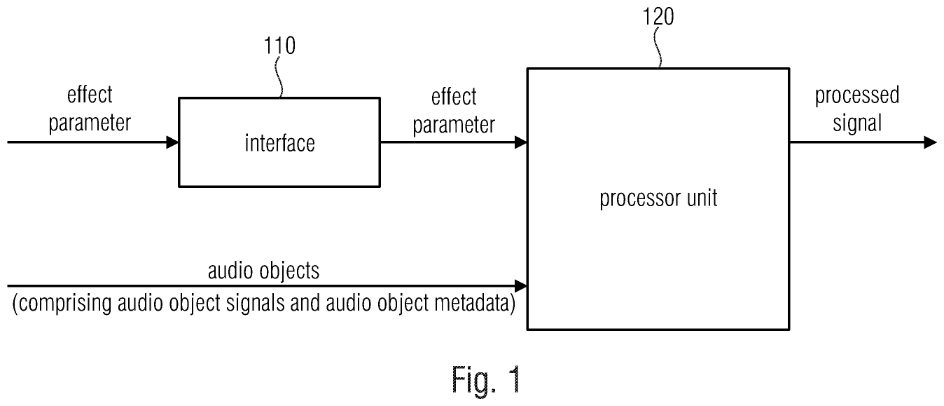

FIG. 1 shows a device for generating a processed signal while using a plurality of audio objects in accordance with an embodiment, each audio object of the plurality of audio objects including an audio object signal and audio object metadata, the audio object metadata including a position of the audio object and a gain parameter of the audio object.

The device comprises: an interface 110 for specification of at least one effect parameter of a processing-object group of audio objects on the part of a user, wherein the processing-object group of audio objects comprises two or more audio objects of the plurality of audio objects.

The device further comprises a processor unit 120 configured to generate the processed signal such that the at least one effect parameter specified by means of the interface 110 is applied to the audio object signal or to the audio object metadata of each of the audio objects of the processing-object group of audio objects.

One or more audio objects of the plurality of audio objects do not belong to the processing-object group of audio objects.

The device described above in FIG. 1 implements an efficient form of audio mastering for audio objects.

The problem with audio objects is that there is often a multitude of audio objects in an audio scene. If these are to be modified, it would involve considerable effort to specify each audio object individually.

According to the invention, a group of two or more audio objects are now organized in a group of audio objects referred to as a processing-object group. A processing-object group is therefore a group of audio objects that are organized in this special group, the processing-object group.

According to the invention, a user may now specify one or more (at least one) effect parameters by means of the interface 110. The processor unit 120 then ensures that the effect parameter is applied to all two or more audio objects of the processing-object group by a single input of the effect parameter.

Such an application of the effect parameter may now consist, for example, in that the effect parameter modifies a certain frequency range of the audio object signal of each of the audio objects of the processing-object group.

Or, the gain parameter of the audio object metadata of each of the audio objects of the processing-object group may be increased or decreased depending on the effect parameter, for example.

Or, the position of the audio object metadata of each of the audio objects of the processing-object group may be modified, for example, depending on the effect parameter. For example, it is conceivable that all audio objects of the processing-object group are shifted by +2 along an x coordinate axis, by −3 along a y coordinate axis and by +4 along a z coordinate axis.

It is also conceivable that the application of an effect parameter to the audio objects of the processing-object group has a different effect on each audio object of the processing-object group. For example, an axis at which the positions of all of the audio objects of the processing-object group are mirrored may be defined as an effect parameter. The change in position of the audio objects of the processing-object group will then have different effects for each audio object of the processing-object group.

For example, in one embodiment, the processor unit 120 may be configured, e.g., not to apply the at least one effect parameter specified by means of the interface to any audio object signal and any audio object metadata of the one or more audio objects that do not belong to the processing-object group of audio objects.

For such an embodiment, it is specified that the effect parameter is precisely not applied to audio objects that do not belong to the processing-object group.

In principle, audio object mastering may be performed either centrally on the encoder side. Or, on the decoder side, the end user as the receiver of the audio object scenery may modify the audio objects himself in accordance with the invention.

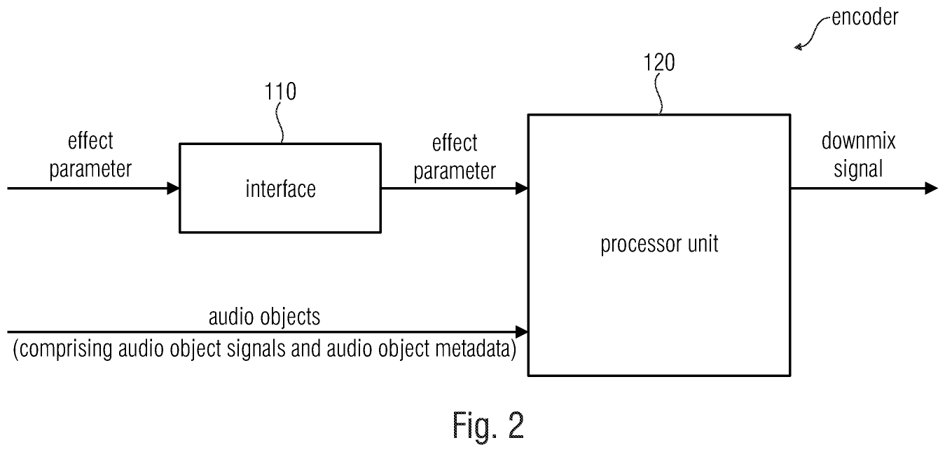

An embodiment that implements audio object mastering on the encoder side in accordance with the invention is shown in FIG. 2.

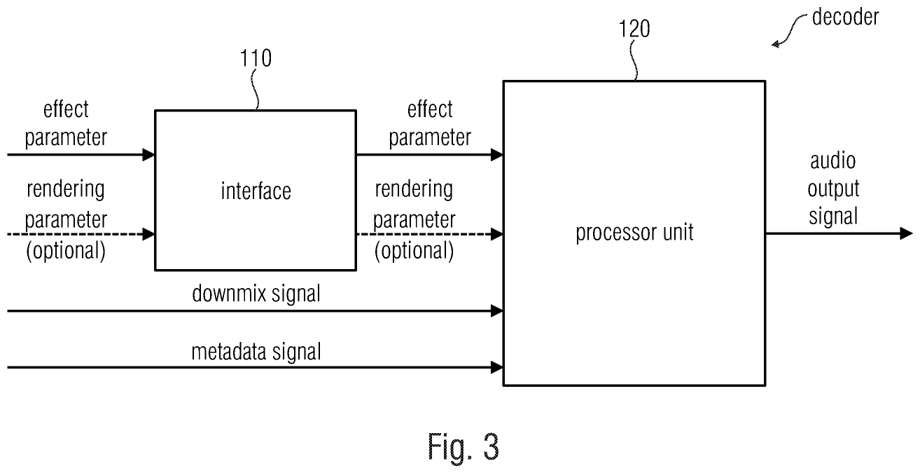

An embodiment that implements audio object mastering on the decoder side in accordance with the invention is shown in FIG. 3.

FIG. 2 shows a device in accordance with a further embodiment, where the device is an encoder.

In FIG. 2 the processor unit 120 is configured to generate a downmix signal while using the audio object signals of the plurality of audio objects. Within this context, the processor unit 120 is configured to generate a metadata signal while using the audio object metadata of the plurality of audio objects.

Furthermore, the processor unit 120 in FIG. 2 is configured to generate the downmix signal as the processed signal, wherein at least one modified object signal for each audio object of the processing-object group of audio objects is mixed in the downmix signal, the processor unit 120 being configured to generate, for each audio object of the processing-object group of audio objects, the modified object signal of this audio object by applying the at least one effect parameter specified by means of the interface 110 to the audio object signal of said audio object.

Or, the processor unit 120 of FIG. 2 is configured to generate the metadata signal as the processed signal, the metadata signal comprising at least one modified position for each audio object of the processing-object group of audio objects, the processor unit 120 being configured to generate, for each audio object of the processing-object group of audio objects, the modified position of said audio object by applying the at least one effect parameter specified by means of the interface 110 to the position of said audio object.

Or, the processor unit 120 of FIG. 2 is configured to generate the metadata signal as the processed signal, the metadata signal comprising at least one modified gain parameter for each audio object of the processing-object group of audio objects, the processor unit 120 being configured to generate, for each audio object of the processing-object group of audio objects, the modified gain parameter of the audio object by applying the at least one effect parameter specified by means of the interface 110 to the gain parameter of said audio object.

FIG. 3 shows a device according to a further embodiment, the device being a decoder. The device of FIG. 3 is configured to receive a downmix signal in which the plurality of audio object signals of the plurality of audio objects are mixed. The device of FIG. 3 is further configured to receive a metadata signal, wherein the metadata signal comprises, for each audio object of the plurality of audio objects, the audio object metadata of said audio object.

The processor unit 120 of FIG. 3 is configured to reconstruct the plurality of audio object signals of the plurality of audio objects on the basis of a downmix signal.

Furthermore, the processor unit 120 of FIG. 3 is configured to generate, as the processed signal, an audio output signal comprising one or more audio output channels.

Furthermore, the processor unit 120 of FIG. 3 is configured to apply the at least one effect parameter specified by means of the interface 110 to the audio object signal of each of the audio objects of the processing-object group of audio objects for generating the processed signal or to apply the at least one effect parameter specified by means of the interface 110 to the position or to the gain parameter of the audio object metadata of each of the audio objects of the processing-object group of audio objects for generating the processed signal.

In audio object decoding, rendering on the decoder side is well known to the person skilled in the art, for example from the SAOC standard (Spatial Audio Object Coding), see [8].

On the decoder side, one or more rendering parameters may be specified by a user input via the interface 110.

For example, in one embodiment, the interface 110 of FIG. 3 may be configured for the specification of one or more rendering parameters on the part of the user. For example, the processor unit 120 of FIG. 3 may be configured to generate the processed signal while using the one or more rendering parameters depending on the position of each audio object of the processing-object group of audio objects.

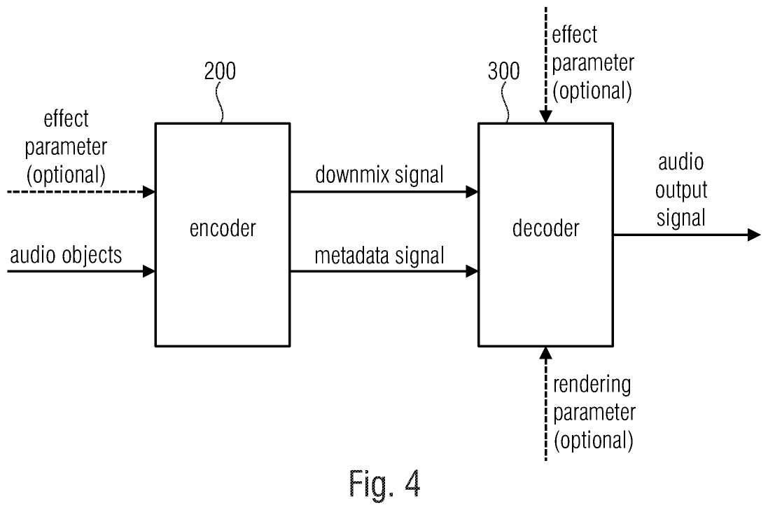

FIG. 4 shows a system in accordance with an embodiment which comprises an encoder 200 and a decoder 300.

The encoder 200 of FIG. 4 is configured to generate a downmix signal on the basis of audio object signals of a plurality of audio objects and to generate a metadata signal on the basis of audio object metadata of the plurality of audio objects, the audio object metadata including a position of the audio object and a gain parameter of the audio object.

The decoder 400 of FIG. 4 is configured to generate an audio output signal comprising one or more audio output channels on the basis of the downmix signal and on the basis of the metadata signal.

The encoder 200 of the system of FIG. 4 may be a device according to FIG. 2.

Or, the decoder 300 of the system of FIG. 4 may be a device according to FIG. 3.

Or, the encoder 200 of the system of FIG. 4 may be a device according to FIG. 2, and the decoder 300 of the system of FIG. 4 may be a device according to FIG. 3.

The following embodiments may be implemented equally in a device of FIG. 1 and in a device of FIG. 2 and in a device of FIG. 3. They may also be implemented in an encoder 200 of the system of FIG. 4 and in a decoder 300 of the system of FIG. 4.

According to an embodiment, the processor unit 120 may be configured, for example, to generate the processed signal in such a way that the at least one effect parameter specified by means of the interface 110 is applied to the audio object signal of each of the audio objects of the processing-object group of audio objects. Within this context, the processor unit 120 may, for example, be configured not to apply the at least one effect parameter specified by means of the interface to any audio object signal of the one or more audio objects of the plurality of audio objects which do not belong to the processing-object group of audio objects.

Such an application of the effect parameter may now consist, for example, in that the application of the effect parameter to the audio object signal of each audio object of the processing-object group modifies, for example, a certain frequency range of the audio object signal of each of the audio objects of the processing-object group.

In one embodiment, the processor unit 120 may, for example, be configured to generate the processed signal in such a way that the at least one effect parameter specified by means of interface 110 is applied to the gain parameter of the metadata of each of the audio objects of the processing-object group of audio objects. Within this context, the processor unit 120 may, for example, be configured not to apply the at least one effect parameter specified by means of the interface to any gain parameters of the audio object metadata of the one or more audio objects of the plurality of audio objects which do not belong to the processing-object group of audio objects.

As described above, in such an embodiment, the gain parameter of the audio object metadata of each of the audio objects of the processing-object group may be increased (e.g. by +3 dB) or decreased as a function of the effect parameter.

According to an embodiment, the processor unit 120 may, for example, be configured to generate the processed signal in such a way that the at least one effect parameter specified by means of interface 110 is applied to the position of the metadata of each of the audio objects of the processing-object group of audio objects. Within this context, the processor unit 120 may, for example, be configured not to apply the at least one effect parameter specified by means of the interface to any position of the audio object metadata of the one or more audio objects of the plurality of audio objects which do not belong to the processing-object group of audio objects.

As already described, in such an embodiment, the position of the audio object metadata of each of the audio objects of the processing-object group may be changed accordingly, for example as a function of the effect parameter. This may be done, for example, by specifying the corresponding x, y, and z coordinate values by which the position of each of the audio objects is to be shifted. Or, for example, a shift (displacement) by a certain angle, rotated around a defined center, for example around a user position, may be specified. Or, for example, doubling (or halving) the distance from a certain point may be provided as an effect parameter for the position of each audio object of the processing-object group.

In one embodiment, the interface 110 may be configured, for example, for specification of at least one definition parameter of the processing-object group of audio objects on the part of the user. Within this context, the processor unit 120 may, for example, be configured to determine, depending on the at least one definition parameter of the processing-object group of audio objects that was specified by means of interface 110, which audio objects of the plurality of audio objects belong to the processing-object group of audio objects.

For example, in accordance with an embodiment, the at least one definition parameter of the processing-object group of audio objects may include at least one position of an area of interest (the position of the area of interest being, for example, the center or center of gravity of the area of interest). The area of interest may be associated with the processing-object group of audio objects. The processor unit 120 may be configured, for example, to determine for each audio object of the plurality of audio objects, depending on the position of the audio object metadata of this audio object and depending on the position of the area of interest, whether this audio object belongs to the processing-object group of audio objects.

In one embodiment, the at least one definition parameter of the processing-object group of audio objects may, for example, further comprise a radius of the area of interest which is associated with the processing-object group of audio objects. The processor unit 120 may, for example, be configured to decide for each audio object of the plurality of audio objects, depending on the position of the audio object metadata of this audio object and depending on the position of the area of interest and depending on the radius of the area of interest, whether this audio object belongs to the processing-object group of audio objects.

For example, a user may specify a position of the processing-object group and a radius of the processing-object group. The position of the processing-object group may specify a spatial center, and the radius of the processing-object group then defines a circle together with the center of the processing-object group. All audio objects having a position inside the circle or on the circle line may then be defined as audio objects of this processing-object group; all audio objects having a position outside the circle will then not be included in the processing-object group. The area inside the circle and on the circle line may then be understood as an “area of interest”.

In accordance with one embodiment, the processor unit 120 may, for example, be configured to determine a weighting factor for each of the audio objects of the processing-object group of Audio Objects depending on a distance between the position of the audio object metadata of this audio object and the position of the area of interest. The processor unit 120 may be configured, for example, for each of the audio objects of the processing-object group of audio objects, to apply the weighting factor of said audio object together with the at least one effect parameter specified by means of interface 110 to the audio object signal or to the gain parameter of the audio object metadata of this audio object.

In such an embodiment, the influence of the effect parameter on the individual audio objects of the processing-object group is individualized for each audio object by determining, in addition to effect parameters, a weighting factor which is individual for each audio object and is applied to the audio object.

In one embodiment, the at least one definition parameter of the processing-object group of audio objects may, for example, comprise at least one angle specifying a direction from a defined user position in which there is an area of interest that is associated with the processing-object group of audio objects. The processor unit 120 may, for example, be configured to determine for each audio object of the plurality of audio objects, depending on the position of the metadata of this audio object and depending on the angle specifying the direction from the defined user position in which the area of interest is located, whether this audio object belongs to the processing-object group of audio objects.

In accordance with an embodiment, the processor unit 120 may, for example, be configured to determine for each of the audio objects of the processing-object group of audio objects a weighting factor which depends on a difference of a first angle and a further angle, wherein the first angle is the angle which specifies the direction from the defined user position in which the area of interest is located, and wherein the further angle depends on the defined user position and on the position of the metadata of this audio object. The processor unit 120 may, for example, be configured to apply, for each of the audio objects of the processing-object group of audio objects, the weighting factor of this audio object together with the at least one effect parameter specified by means of interface 110 to the audio object signal or to the gain parameter of the audio object metadata of this audio object.

In one embodiment, the processing-object group of audio objects may, for example, be a first processing-object group of audio objects; for example, one or more further processing-object groups of audio objects may exist in addition to it.

Each processing-object group of the one or more further processing-object groups of audio objects may comprise one or more audio objects of the plurality of audio objects; at least one audio object of a processing-object group of the one or more further processing-object groups of audio objects is not an audio object of the first processing-object group of audio objects.

Here, the interface 110 may be configured, for each processing-object group of the one or more further processing-object groups of audio objects, for specification of at least one further effect parameter for this processing-object group of audio objects on the part of the user.

Within this context, the processor unit 120 may be configured to generate the processed signal in such a way that for each processing-object group of the one or more further processing-object groups of audio objects, the at least one further effect parameter of this processing-object group that was specified by means of the interface 110 is applied to the audio object signal or to the audio object metadata of each of the one or more audio objects of this processing-object group; one or more audio objects of the plurality of audio objects do not belong to this processing-object group.

Here, the processor unit 120 may, for example, be configured not to apply the at least one further effect parameter of this processing-object group that was specified by means of the interface to any audio object signal and any audio object metadata of the one or more audio objects which do not belong to this processing-object group.

This means that more than one processing-object group may exist in such embodiments. For each of the processing-object groups, one or more separate effect parameters are determined.

In accordance with an embodiment, the interface 110 may be configured, in addition to the first processing-object group of audio objects, for example, for the specification of the one or more further processing-object groups of one or more audio objects on the part of the user, in that the interface 110 is configured for each processing-object group of the one or more further processing-object groups of one or more audio objects for the specification of at least one definition parameter of this processing-object group on the part of the user.

Within this context, the processor unit 120 may be configured, for example, to determine for each processing-object group of the one or more further processing-object groups of one or more audio objects, as a function of the at least one definition parameter of this processing-object group that is specified by means of the interface 110, which audio objects of the plurality of audio objects belong to this processing-object group.

In the following, concepts of embodiments of the invention and advantageous embodiments will be described.

In embodiments, any kind of global adaptation in OBAP is made possible by converting global adaptations to individual changes of the affected audio objects (e.g. by the processor unit 120).

Spatial mastering for object-based audio production may be implemented as follows, for example, by implementing inventive processing objects.

The proposed implementation of overall adaptations is put into practice by means of processing objects (POs). Like ordinary audio objects, they may be freely positioned anywhere within a scene in real time. The user may apply any signal processing to the processing object (to the processing-object group), for example equalizer (EQ) or compression. For each of these processing tools, the parameter settings of the processing object may be converted to object-specific settings. Various procedures are presented for this calculation.

In the following, an area of interest will be addressed.

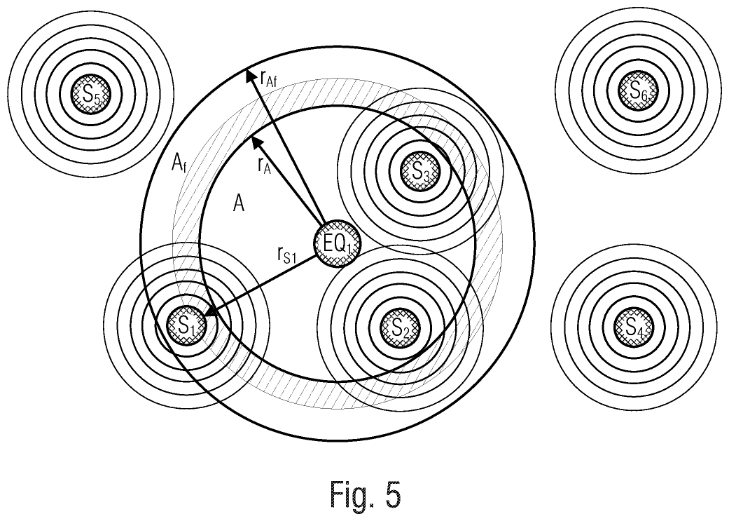

FIG. 5 shows a processing object comprising the area A and the fading area A_{f} in accordance with an embodiment.

As shown in FIG. 5, the user defines an area A and a fading area A_{f} around the processing object. The processing parameters of the processing object are divided into constant parameters and weighted parameters. Values of constant parameters are passed on unchanged by all audio objects within A and A_{f}. Weighted parameter values are passed on only by audio objects within A. Audio objects within A_{f} are weighted with a distance factor. The decision as to which parameters are weighted and which are not depends on the type of parameter.

Given the user-defined value p_{M} of such a weighted parameter for the processing object, the parameter function pᵢ is defined as follows for each audio object Sᵢ:

$${p}_{i} ( t ) = \{ \begin{matrix}{p}_{M} ( t ) , & for {S}_{i} ∈ A \\ {p}_{M} ( t ) * {f}_{i} ( t ) , & for {S}_{i} ∈ {A}_{f} \\ 0 , & else .\end{matrix} \} , \qquad ( 1 )$$

where the factor fᵢ is given as follows:

$${f}_{i} ( t ) = \frac{{r}_{{A}_{f}} - {r}_{{S}_{i}}}{{r}_{{A}_{f}} - {r}_{A}} . \qquad ( 2 )$$

Consequently, if the user specifies r_{A}=0, there will be no validity range within which weighted parameters are kept constant.

The following describes a calculation of inverse parameters in accordance with an embodiment.

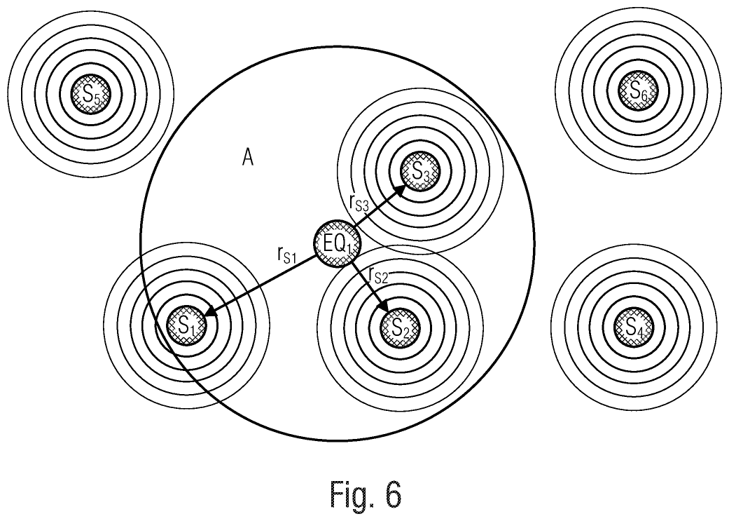

FIG. 6 shows a processing object comprising the area A and object radii in accordance with an embodiment.

User adjustments to the processing object which are transformed via equation (1) may not lead to the desired results fast enough since the exact position of audio objects is not taken into account. If, for example, the area around the processing object is very large and if the audio objects comprised are far away from the processing-object position, the effect of calculated adjustments may possibly not be audible even at the processing-object position.

For gain parameters, a different calculation method based on the decay rate of each object is conceivable. Again, within a user-defined area of interest shown in FIG. 6, the individual parameter pᵢ for each audio object is calculated as follows.

$${p}_{i} ( t ) = \{ \begin{matrix}{h}_{i} ( t ) , & for {S}_{i} ∈ A \\ 0 , & else .\end{matrix} \} , \qquad ( 3 )$$

where hᵢ might be defined as follows

$${h}_{i} ( t ) = sgn {g}_{e} ( t ) * ( \vert {g}_{e} ( t ) \vert + \vert 10 * {{log}_{10} ( \frac{{a}_{i}}{{d}_{i} ( t )} )}^{2} \vert ) . \qquad ( 4 )$$

aᵢ is a constant for the nearest possible distance from an audio object, and dᵢ(t) is the distance from the audio object to the EQ object. Derived from the distance law, the function has been modified to correctly handle possible positive or negative EQ gain changes.

In the following modified embodiment, an angle-based calculation will be performed.

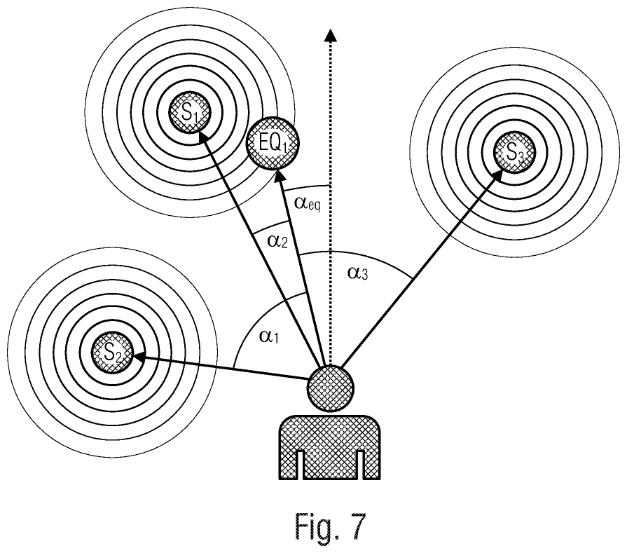

The previous calculations were based on the distance between audio objects and the processing object. However, from a user's perspective, the angle between the processing object and the surrounding audio objects may occasionally provide a more accurate representation of their listening impression. [5] suggests global control of any audio plug-in parameter via the azimuth of audio objects. This approach may be adopted by calculating the difference in the angle aᵢ between the processing object with offset angle α_{eq} and audio objects Sᵢ around it, as shown in FIG. 7.

Thus, FIG. 7 shows a relative angle of audio objects to the processing object in accordance with an embodiment.

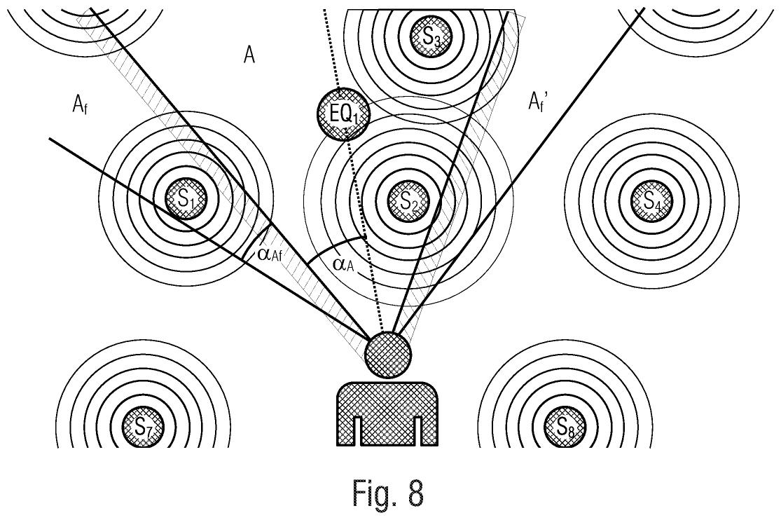

The user-defined area of interest addressed above might be modified while using the angles α_{A} and α_{A}_{_{f}}, which is shown in FIG. 8.

FIG. 8 shows an equalizer object with a new radial circumference in accordance with an embodiment.

With regard to the blanking area (fade-out area, German: Ausblendungsbereich), A_{f}, fᵢ would have to be newly defined as follows:

$${f}_{i} ( t ) = \frac{{α}_{{A}_{f}} - {α}_{{S}_{i}}}{{α}_{{A}_{f}} - {α}_{A}} . \qquad ( 5 )$$

Although for the modified approach presented above, the distance dᵢ in this context might simply be interpreted as the angle between the audio object and the EQ object, this would no longer justify applying the distance law. Therefore, only the user-defined area is changed, while the gain calculation is maintained as before.

In one embodiment, the application implemented is equalization.

Equalization may be considered the most important tool in mastering, since the frequency response of a mix is the most critical factor for good translation (transformation) across reproduction systems.

The proposed implementation of equalization is put into practice via EQ objects. Since all other parameters are not dependent on distance, only the gain parameter is of special interest.

In a further embodiment, the application implemented is dynamic control.

In conventional mastering, dynamic compression is used to control dynamic deviations in a mix over time. Depending on the compression settings, this changes the perceived density and the transient response of a mix. In the case of fixed compression, the perceived change in density is referred to as ‘glue’, while more intense compression settings may be used for pump or side-chain effects on beat-heavy mixes.

With OBAP, the user might readily specify identical compression settings for multiple adjacent objects to obtain multi-channel compression. However, the summed compression on groups of audio objects would not only be advantageous for time-critical workflows, but it would also be more likely that the psychoacoustic impression would be achieved by so-referred to as “glued” signals.

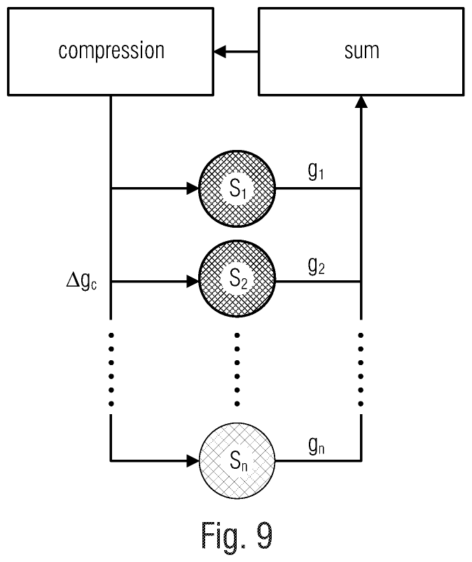

FIG. 9 shows a signal flow of a compression of the signals from n sources in accordance with an embodiment.

In accordance with to another embodiment, the application implemented is scene transformation.

In stereo mastering, mid/side processing is a commonly used technique to enhance or stabilize the stereo image of a mix. For spatial audio mixes, a similar option may be helpful if the mix was created in an acoustically critical environment with potentially asymmetrical room or speaker characteristics. New creative possibilities for the ME might also be provided in order to improve the effects of a mix.

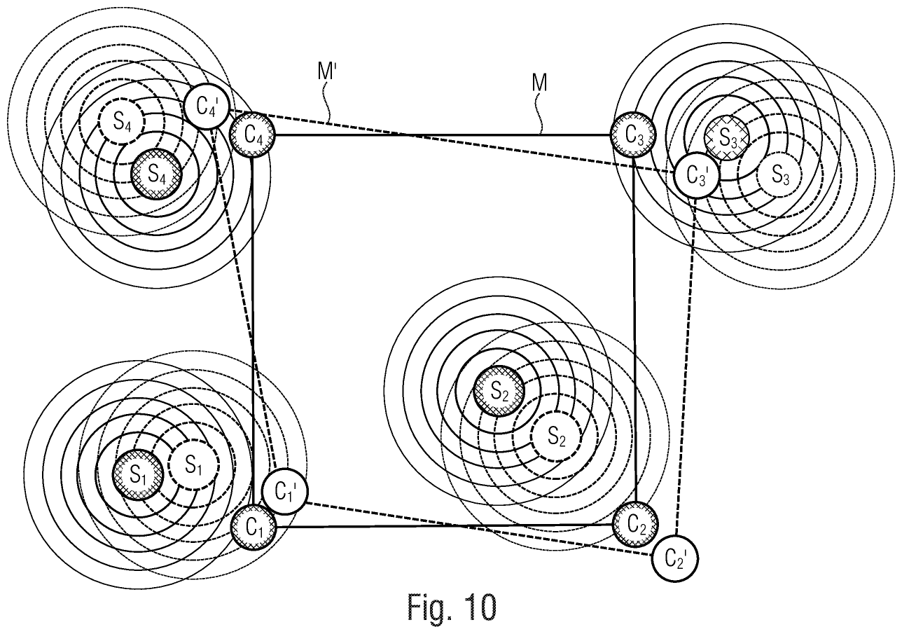

FIG. 10 shows a scene transformation while using a control panel M in accordance with an embodiment. Specifically, FIG. 10 shows a schematic transformation while using a distortion range with user-draggable borders C₁ to C₄.

Two-dimensional transformation of a scene within the horizontal plane may be implemented while using a homography transformation matrix H, which maps each audio object at the position pᵢ to a new position p′ᵢ, see also [7]:

$$H := ( \begin{matrix}h 1 & h 2 & h 3 \\ h 4 & h 5 & h 6 \\ h 7 & h 8 & h 9\end{matrix} ) , {p}_{i}^{′} = {Hp}_{i} . \qquad ( 6 )$$

If the user distorts, with a control field, M to M′ while using the four draggable corners C₁₋₄ (see FIG. 6), their 2D coordinates

$$[ \begin{matrix}{x}_{1 - 4} \\ {y}_{1 - 4}\end{matrix} ]$$

may be used for a linear system of equations (7) to obtain the coefficients of H[7].

$$( \begin{matrix}{x}_{1} & {y}_{1} & 1 & 0 & 0 & 0 & - {x}_{1}^{′} {x}_{1} & - {x}_{1}^{′} {y}_{1} \\ 0 & 0 & 0 & {x}_{1} & {y}_{1} & 1 & - {y}_{1}^{′} {x}_{1} & - {y}_{1}^{′} {y}_{1} \\ {x}_{2} & {y}_{2} & 1 & 0 & 0 & 0 & - {x}_{2}^{′} {x}_{2} & - {x}_{2}^{′} {y}_{2} \\ 0 & 0 & 0 & {x}_{2} & {y}_{2} & 1 & - {y}_{2}^{′} {x}_{2} & - {y}_{2}^{′} {y}_{2} \\ {x}_{3} & {y}_{3} & 1 & 0 & 0 & 0 & - {x}_{3}^{′} {x}_{3} & - {x}_{3}^{′} {y}_{3} \\ 0 & 0 & 0 & {x}_{3} & {y}_{3} & 1 & - {y}_{3}^{′} {x}_{3} & - {y}_{3}^{′} {y}_{3} \\ {x}_{4} & {y}_{4} & 1 & 0 & 0 & 0 & - {x}_{4}^{′} {x}_{4} & - {x}_{4}^{′} {y}_{4} \\ 0 & 0 & 0 & {x}_{4} & {y}_{4} & 1 & - {y}_{4}^{′} {x}_{4} & - {y}_{4}^{′} {y}_{4}\end{matrix} ) * ( \begin{matrix}h 1 \\ h 2 \\ h 3 \\ h 4 \\ h 5 \\ h 6 \\ h 7 \\ h 8\end{matrix} ) = ( \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ {x}_{4}^{′} \\ {y}_{4}^{′}\end{matrix} ) \qquad ( 7 )$$

Since audio object positions may vary over time, the coordinate positions may be interpreted as time-dependent functions.

In embodiments, dynamic equalizers are implemented. Other embodiments implement multiband compression.

Object-based sound adjustments are not limited to the equalizer applications introduced.

The above description will be supplemented below by a more general description of embodiments.

Object-based three-dimensional audio production follows the approach that audio scenes are computed and reproduced in real time for almost any arbitrary speaker configurations via a rendering process. Audio scenes describe the arrangement of audio objects as a function of time. Audio objects consist of audio signals and metadata. These metadata include, among others, the position in the room and the volume. In order to edit the scene, the user previously has had to change all audio objects of a scene individually.

When we talk about a processing-object group, on the one hand, and a processing object, on the other hand, it should be noted that for each processing object, a processing-object group is defined that includes audio objects. The processing-object group is also referred to as the container of the processing object. For each processing object, therefore, a group of audio objects is defined among the plurality of audio objects. The corresponding processing-object group comprises the group of audio objects thus specified. A processing-object group is therefore a group of audio objects.

Processing objects may be defined as objects that may change the properties of other audio objects. Processing objects are artificial containers with which any audio objects may be associated, that is, the container is used to address all of its associated audio objects. The associated audio objects are influenced via any number of effects. Processing objects thus enable the user to process several audio objects simultaneously.

A processing object has, for example, position, association procedure, container, weighting procedure, audio signal processing effects and metadata effects.

The position is a position of the processing object in a virtual scene.

The association procedure associates audio objects with the processing object (possibly while using their positions).

The container (or connections) is the set of all audio objects associated with the processing object (or possibly of additional other processing objects).

Weighting procedures are the algorithms for calculating the individual effect parameter values for the associated audio objects.

Audio signal processing effects change the respective audio component of audio objects (for example, equalizers, dynamics).

Metadata effects change the metadata of audio objects and/or processing objects (e.g. position distortion).

Similarly, the processing-object group may have associated with it the position, association procedure, container, weighting procedure, audio signal processing effects and metadata effects described above. Here, the audio objects of the processing objects container are the audio objects of the processing-object group.

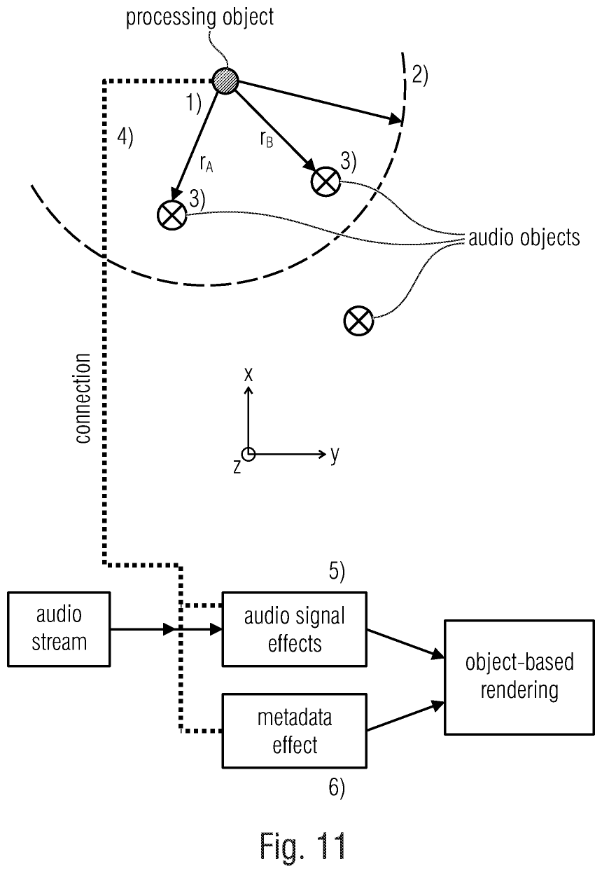

FIG. 11 shows the connection of a processing object with which audio signal effects and metadata effects are effected, in accordance with an embodiment.

In the following, properties of processing objects will be described in accordance with specific embodiments:

Processing objects may be placed within a scene by the user as desired, the position may be set to be constant over time or as a function of time.

Processing objects may have effects assigned to them by the user that change the audio signal and/or the metadata of audio objects. Examples for effects are equalization of the audio signal, processing of the dynamics of the audio signal, or a change in the position coordinates of audio objects.

Processing objects may have any number of effects assigned to them in any order.

Effects change the audio signal and/or the metadata of the associated set of audio objects, either in a manner that is constant over time or that is time-dependent.

Effects have parameters for controlling processing of signal and/or metadata. These parameters are divided into constant and weighted parameters by the user, or in a manner defined by their respective type.

The effects of a processing object are copied and applied to its associated audio objects.

The values of constant parameters are adopted unchanged by each audio object. The values of weighted parameters are calculated individually for each audio object by using different weighting methods. The user may select a weighting method for each effect, or may activate or deactivate it for individual audio sources.

The weighting methods take individual metadata and/or signal characteristics of individual audio objects into account. This corresponds, for example, to the distance between an audio object and the processing object or to the frequency spectrum of an audio object. The weighting methods may also take into account the listening position of the listener. Furthermore, the weighting methods may also combine the mentioned properties of audio objects in order to derive individual parameter values. For example, the sound levels of audio objects may be added in the context of dynamic processing in order to derive an individual change in volume for each audio object.

effect parameters may be set to be constant over time or to be time-dependent. The weighting methods take such temporal changes into account.

Weighting methods may also process information that the audio renderer analyzes from the scene.

The sequence of the assignment of effects to the processing object corresponds to the sequence of processing signals and/or metadata of each audio object, i.e. the data modified by a previous effect is used by the next effect as a basis for its calculation. The first effect works on the basis of the yet unchanged data of an audio object.

Individual effects may be deactivated. Then the calculated data of the previous effect, if there is any, will be forwarded to the effect following the deactivated effect.

An explicitly newly developed effect is the change in the position of audio objects by means of homography (“distortion effect”). The user is shown a rectangle with individually moveable corners at the position of the processing object. If the user moves a corner, a transformation matrix for this distortion will be calculated from the previous state of the rectangle and the newly distorted state. The matrix is then applied to all position coordinates of the audio objects associated with the processing object so that their position(s) change(s) in accordance with the distortion.

Effects that change only metadata may also be applied to other processing objects (“distortion effect”, inter alia).

Audio sources may be associated with the processing objects in a number of ways. The number of associated audio objects may change over time, depending on the type of association. This change is taken into account in all calculations.

A zone of influence may be defined around the position of processing objects.

All audio objects that are positioned within the zone of influence form the associated set of audio objects to which the effects of the processing object are applied.

The zone of influence may be any body (three-dimensional) or any shape (two-dimensional) defined by the user.

The center of the zone of influence may or may not correspond to the position of the processing object. This is specified by the user.

An audio object lies within a three-dimensional zone of influence if its position lies within the three-dimensional body.

An audio object lies within a two-dimensional zone of influence if its position projected onto the horizontal plane lies within the two-dimensional shape.

The zone of influence may assume an unspecified, all-encompassing size, so that all audio objects within a scene are located within the zone of influence.

If need be, the zones of influence adapt to changes in the scene properties (e.g. scene scaling).

Regardless of the zone of influence, processing objects may be linked to any selection of audio objects within a scene.

The coupling may be defined by the user such that all selected audio objects form a set of audio objects to which the effects of the processing object are applied.

Alternatively, the coupling may be defined by the user in such a way that the processing object adjusts its position, as a function of time, according to the position of the selected audio objects. This positional adjustment may take into account the listening position of the listener. Within this context, the effects of the processing object do not necessarily have to be applied to the coupled audio objects.

Association may be done automatically on the basis of user-defined criteria. Within this context, all audio objects of a scene are continuously checked for the defined criteria, and if the criteria are met, they are associated with the processing object. The duration of the association may be limited to the time during which the criterion is/the criteria are met, or transition periods may be defined. The transition periods determine the time period during which one criterion or more criteria may be continuously met by the audio object so that it will be associated with the processing object, or the time period during which one criterion or more criteria may be continuously violated so that the association with the processing object is dissolved again.

Processing objects may be deactivated by the user so that their properties are retained and are still displayed to the user without any audio objects being influenced by the processing object.

The user may couple any number of properties of a processing object with similar properties of any number of other processing objects. These properties include parameters of effects. The user may choose whether the coupling is absolute or relative. If the coupling is constant, the changed property value of a processing object is adopted exactly by all coupled processing objects. With relative coupling, the value of the change is offset against the property values of coupled processing objects.

Processing objects may be duplicated. When doing so, a second processing object having properties identical to those of the original processing object is created. The properties of the processing objects are then independent of each other.

Properties of processing objects may be passed on permanently, for example, when they are copied, so that any changes made to the parents are automatically adopted in the children.

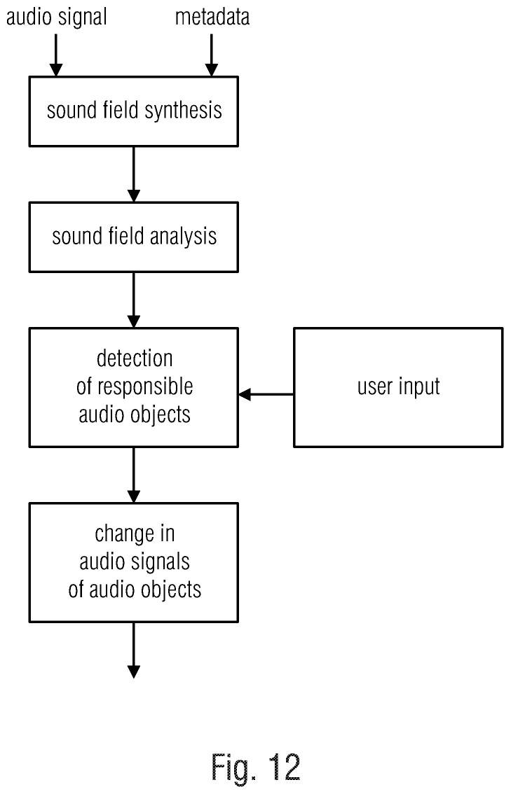

FIG. 12 shows the modification of audio objects and audio signals in response to a user input in accordance with an embodiment.

Another new application of processing objects is intelligent parameter calculation using a scene analysis. The user defines effect parameters at a certain position via the processing object. The audio renderer performs a predictive scene analysis so as to detect which audio sources influence the position of the processing object. Then, while taking into account the scene analysis, effects are applied to the selected audio sources in such a way that the user-defined effect settings are best achieved at the position of the processing object.

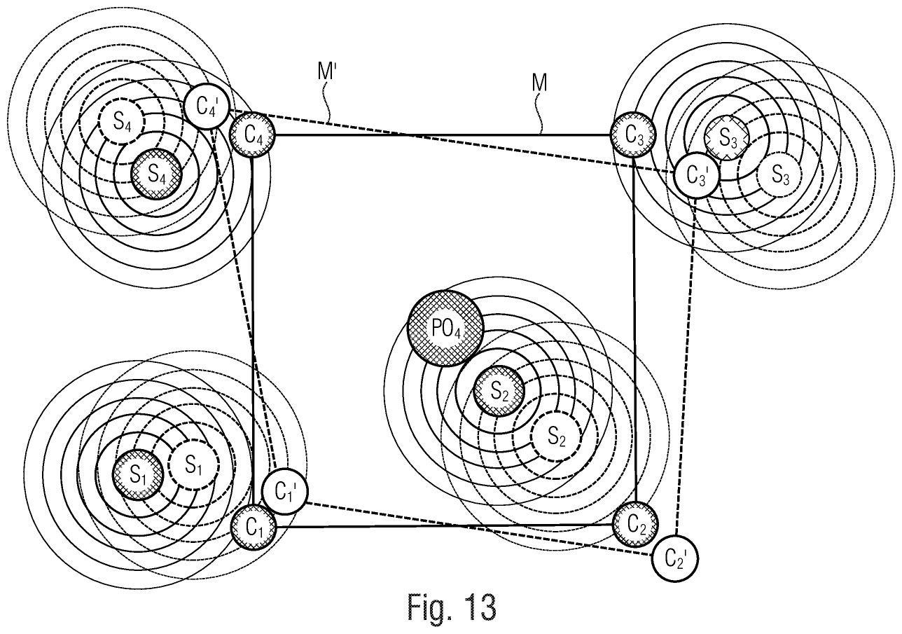

In the following, further embodiments of the invention, which are visually represented by FIG. 13-FIG. 25, will be described.

For example, FIG. 13 shows processing object PO₄ with rectangle M for distortion of the corners C₁, C₂, C₃ and C₄ on the part of the user. FIG. 13 schematically shows a possible distortion towards M′ with the corners C₁′, C₂′, C₃′ and C₄′, and the corresponding effect on the sources S₁, S₂, S₃ and S₄ with their new positions S₁′, S₂′, S₃′ and S₄′.

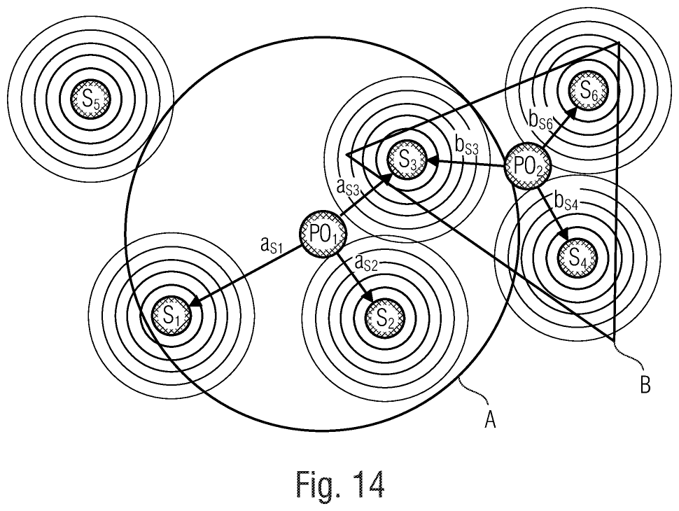

FIG. 14 shows processing objects PO₁ and PO₂ with their respective overlapping two-dimensional zones of influence A and B, as well as the distances a_{S}_{₁}, a_{S}_{₂} and a_{S}_{₃} and b_{S}_{₃}, b_{S}_{₄} and b_{S}_{₆}, respectively, between the respective processing object and the sources S₁, S₂, S₃, S₄ and S₆ associated by the zones of influence.

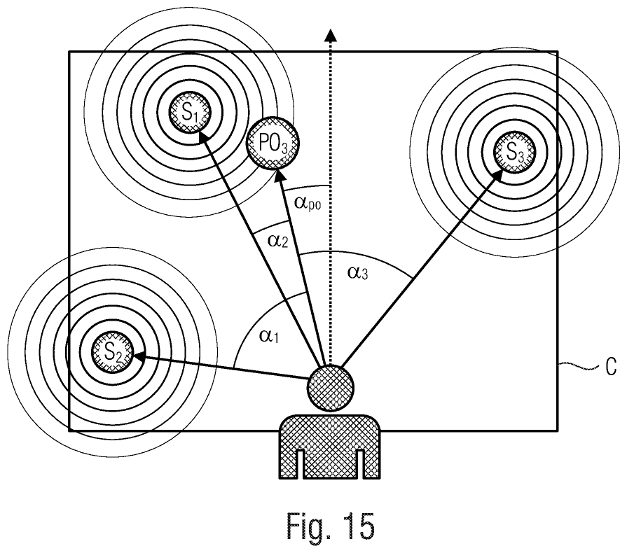

FIG. 15 shows the processing object PO₃ with the rectangular, two-dimensional zone of influence C and the angles between PO₃ and the associated sources S₁, S₂ and S₃ for a possible weighting of parameters that includes the listening position of the listener. The angles may be determined by the difference of the azimuth of the individual sources and the azimuth αₚₒ of PO₃.

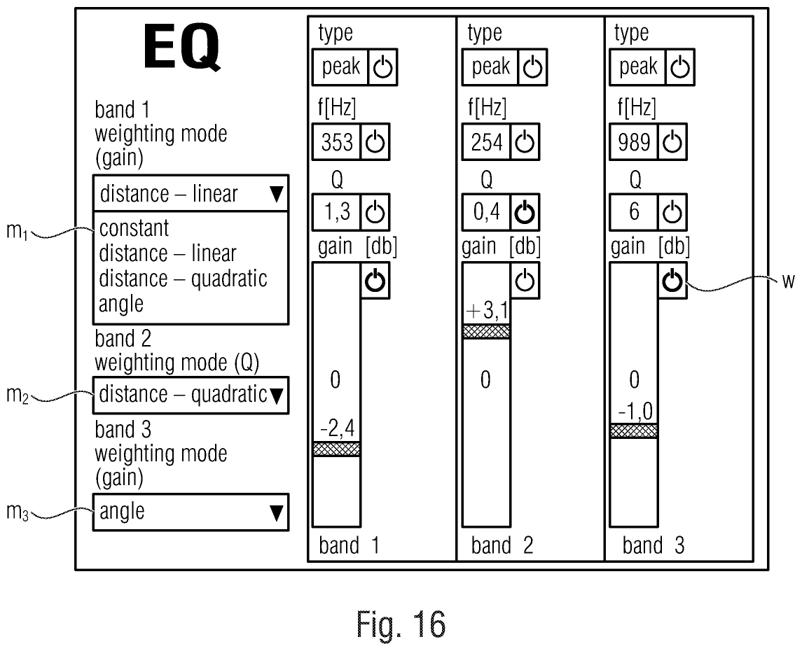

FIG. 16 shows a possible schematic implementation of an equalizer effect applied to a processing object. Buttons such as w next to each parameter may be used to activate the weighting for the respective parameter. m₁, m₂ and m₃ provide options for the weighting procedure for the weighted parameters mentioned.

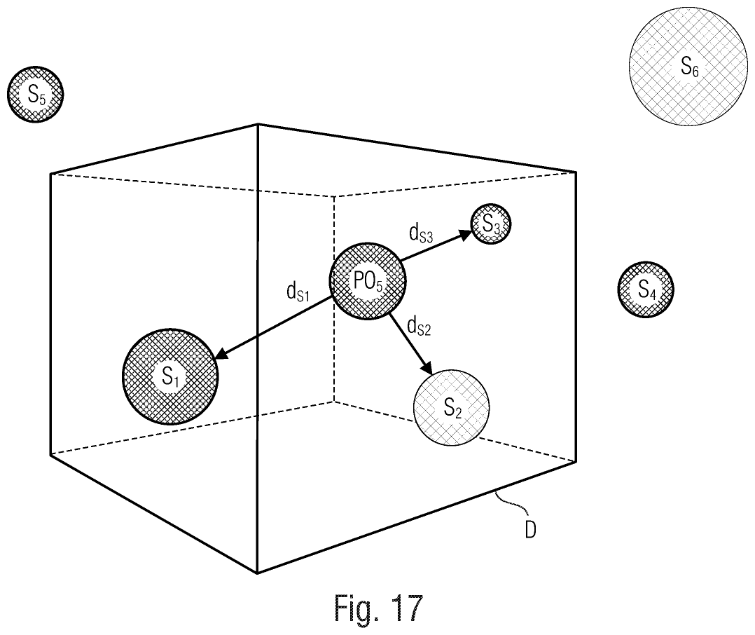

FIG. 17 shows the processing object PO₃ with a three-dimensional zone of influence D and the respective distances d_{S}_{₁}, d_{S}_{₂} and d_{S}_{₃} from the sources S₁, S₂, and S₃ associated via the zone of influence.

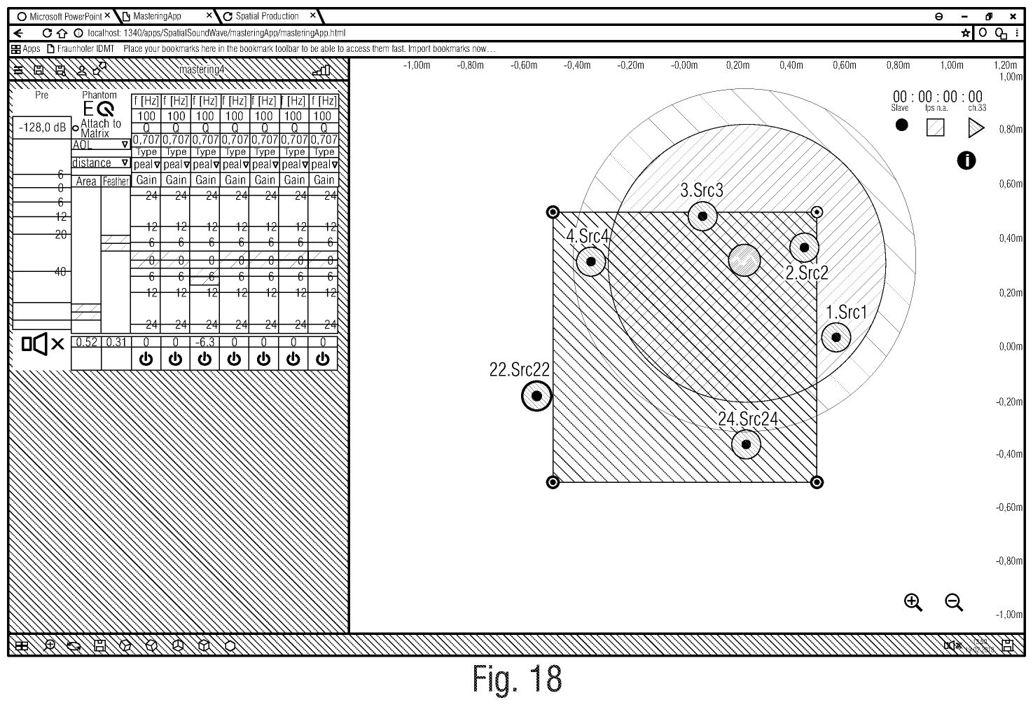

FIG. 18 shows a prototypical implementation of a processing object to which an equalizer was applied. The turquoise object with the wave symbol on the right side of the image shows the processing object in the audio scene, which the user may move freely with the mouse. Within the turquoise, transparent homogeneous area around the processing object, the equalizer parameters are applied unchanged to the audio objects Src1, Src2 and Src3 as defined on the left side of the image. Around the homogeneous circular area, the shading moving into the transparent area indicates the area in which all parameters except the gain parameters are adopted unchanged by the sources. The gain parameters of the equalizer, on the other hand, are weighted in accordance with the distance between the sources and the processing object. Since only the source Src4 and the source Src24 are located within this area, weighting will take place for their parameters only in this case. The source Src22 is not influenced by the processing object. The user controls the size of the radius of the circular area around the processing object via the “Area” slider. Via the “Feather” slider, the user controls the size of the radius of the surrounding transition area.

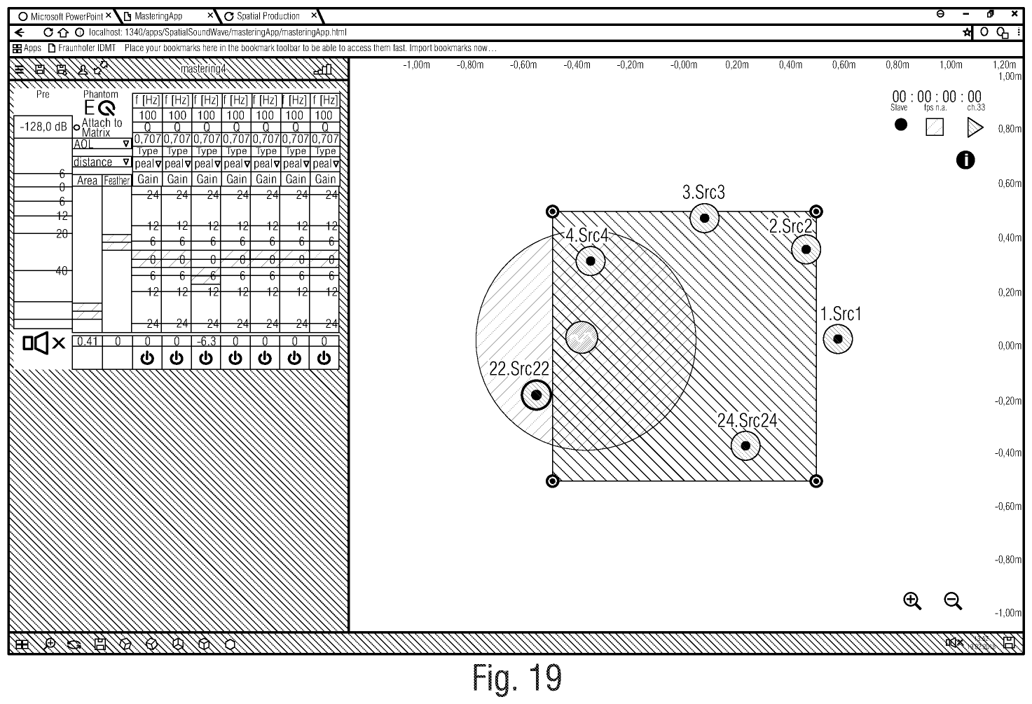

FIG. 19 shows a processing object as in FIG. 18, but in a different position and without a transition area. All parameters of the equalizer are adopted unchanged to the sources Src22 and Src4. The sources Src3, Src2, Src1 and Src24 are not influenced by the processing object.

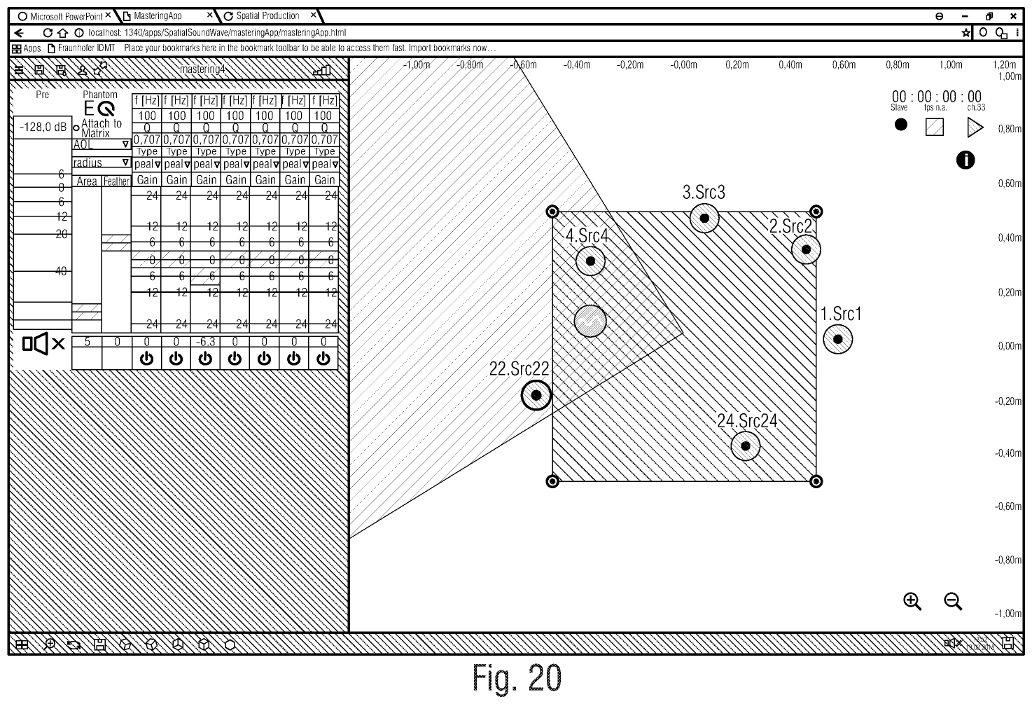

FIG. 20 shows a processing object with an area defined as a zone of influence via its azimuth, so that the sources Src22 and Src4 are associated with the processing object. The peak of the zone of influence in the middle of the right side of the image corresponds to the position of the listener/user. When the processing object is moved, the area is moved in accordance with the azimuth. With the “Area” slider, the user determines the size of the angle of the zone of influence. The user achieves the change from a circular to an angle-based surface of influence via the lower selection field via the “Area”/“Feather” sliders, which now displays “radius”.

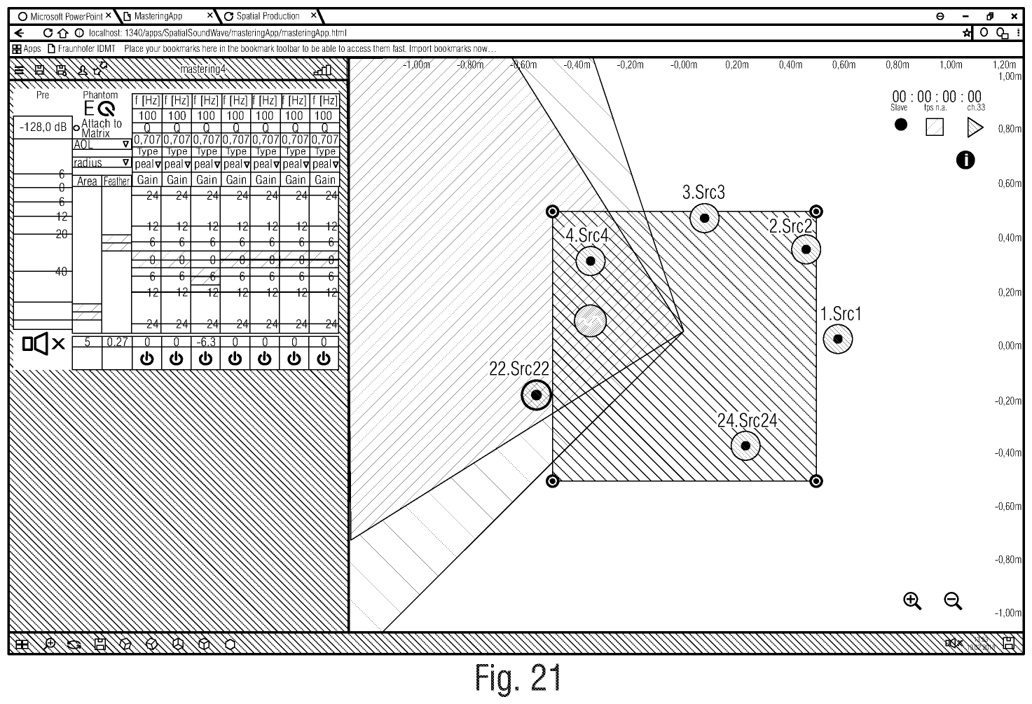

FIG. 21 shows a processing object as in FIG. 20, but with an additional transition area that may be controlled by the user via the “Feather” slider.

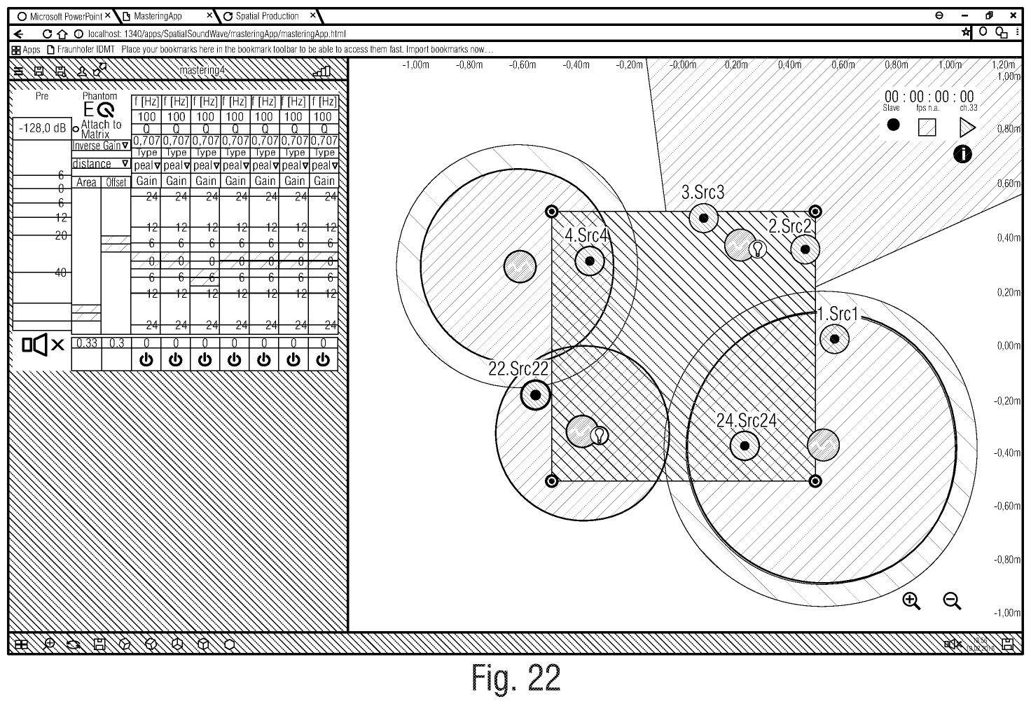

FIG. 22 shows several processing objects within the scene, with different zones of influence. The gray processing objects have been deactivated by the user, i.e. they do not influence the audio objects within their zone of influence. On the left side of the image, the equalizer parameters of the currently selected processing object are displayed. The selection is indicated by a thin, light turquoise line around the object.

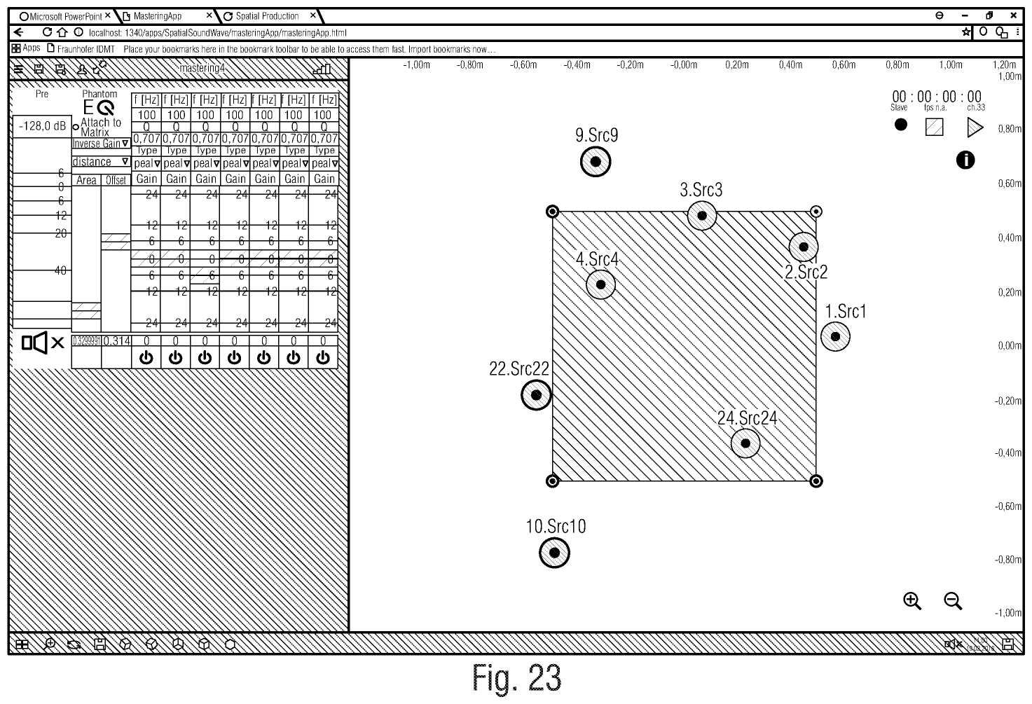

FIG. 23 shows the red square on the right side of the image shows a processing object for horizontal distortion of the positions of audio objects. The user may drag the corners in any direction with the mouse so as to achieve a distortion of the scene.

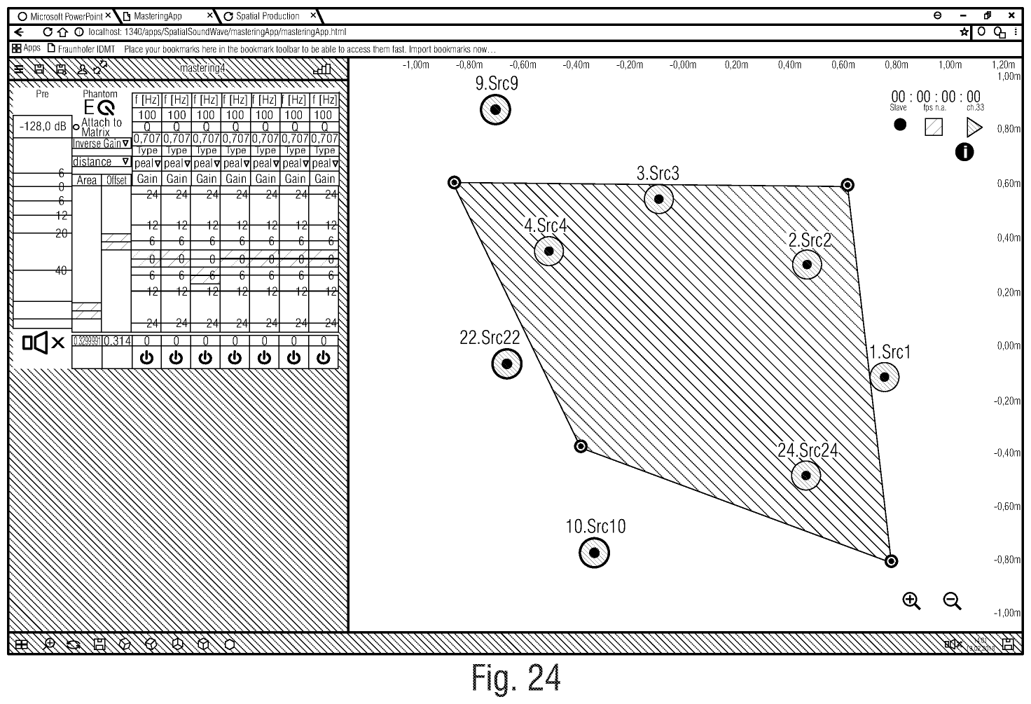

FIG. 24 shows the scene after the user has dragged the corners of the processing object. The positions of all sources have changed in accordance with the distortion.

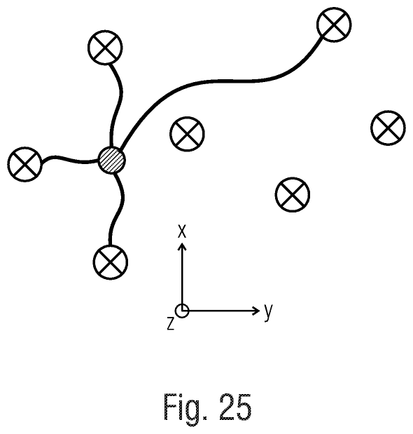

FIG. 25 shows a possible visualization of the association of individual audio objects with a processing object.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device. Some or all of the method steps may be performed by a hardware device (or while using a hardware device) such as a microprocessor, a programmable computer or an electronic circuit, for example. In some embodiments, some or several of the most important method steps may be performed by such a device.

Depending on specific implementation requirements, embodiments of the invention may be implemented in hardware or in software or at least partly in hardware or at least partly in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing a method described herein, said computer program being stored on a machine-readable carrier. In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier or the digital storage medium or the computer-readable medium are typically concrete and/or non-transitory.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU) or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

Coleman, P., Franck, A., Francombe, J., Liu, Q., Campos, T. D., Hughes, R., Men-zies, D., Galvez, M. S., Tang, Y., Woodcock, J., Jackson, P., Melchior, F., Pike, C., Fazi, F., Cox, T, and Hilton, A., “An Audio-Visual System for Object-Based Audio: From Recording to Listening,” IEEE Transactions on Multimedia, PP(99), pp. 1-1, 2018, ISSN 1520-9210, doi:10.1109/TMM.2018.2794780.
2] Gasull Ruiz, A., Sladeczek, C., and Sporer, T., “A Description of an Object-Based Audio Workflow for Media Productions,” in Audio Engineering Society Conference: 57th International Conference: The Future of Audio Entertainment Technology, Cinema, Television and the Internet, 2015.
3] Melchior, F., Michaelis, U., and Steffens, R., “Spatial Mastering—a new concept for spatial sound design in object-based audio scenes,” in Proceedings of the International Computer Music Conference 2011, 2011.
4] Katz, B. and Katz, R. A., Mastering Audio: The Art and the Science, Butterworth-Heinemann, Newton, Mass., USA, 2003, ISBN 0240805453, AES Conference on Spatial Reproduction, Tokyo, Japan, 2018 Aug. 6-9, page 2
5] Melchior, F., Michaelis, U., and Steffens, R., “Spatial Mastering—A New Concept for Spatial Sound Design in Object-based Audio Scenes,” Proceedings of the International Computer Music Conference 2011, University of Huddersfield, U K, 2011.
6] Sladeczek, C., Neidhardt, A., Bohme, M., Seeber, M., and Ruiz, A. G., “An Approach for Fast and Intuitive Monitoring of Microphone Signals Using a Virtual Listener,” Proceedings, International Conference on Spatial Audio (ICSA), 21.2.-23.2.2014, Erlangen, 2014
7] Dubrofsky, E., Nomography Estimation, Master's thesis, University of British Columbia, 2009.
8] ISO/IEC 23003-2:2010 Information technology—MPEG audio technologies—Part 2: Spatial Audio Object Coding (SAOC); 2010

1. Device for generating a processed signal while using a plurality of audio objects, each audio object of the plurality of audio objects comprising an audio object signal and audio object metadata, the audio object metadata comprising a position of the audio object and a gain parameter of the audio object, the device comprising:
an interface for specification of at least one effect parameter of a processing-object group of audio objects on the part of a user, the processing-object group of audio objects comprising two or more audio objects of the plurality of audio objects, and
a processor unit configured to generate the processed signal such that the at least one effect parameter specified by means of the interface is applied to the audio object signal or to the audio object metadata of each of the audio objects of the processing-object group of audio objects.

2. Device as claimed in claim 1,
wherein one or more audio objects of the plurality of audio objects do not belong to the processing-object group of audio objects, and wherein the processor unit is configured not to apply the at least one effect parameter specified by means of the interface to any audio object signal and any audio object metadata of the one or more audio objects which do not belong to the processing-object group of audio objects.

3. Device as claimed in claim 2,
wherein the processor unit is configured to generate the processed signal such that the at least one effect parameter specified by means of the interface is applied to the audio object signal of each of the audio objects of the processing-object group of audio objects,
wherein the processor unit is configured not to apply the at least one effect parameter specified by means of the interface to any audio object signal of the one or more audio objects of the plurality of audio objects that do not belong to the processing-object group of audio objects.

4. Device as claimed in claim 2,
wherein the processor unit is configured to generate the processed signal such that the at least one effect parameter specified by means of the interface is applied to the gain parameter of the metadata of each of the audio objects of the processing-object group of audio objects,
wherein the processor unit is configured not to apply the at least one effect parameter specified by means of the interface to any gain parameter of the audio object metadata of the one or more audio objects of the plurality of audio objects that do not belong to the processing-object group of audio objects.

5. Device as claimed in claim 2,
wherein the processor unit is configured to generate the processed signal such that the at least one effect parameter specified by means of the interface is applied to the position of the metadata of each of the audio objects of the processing-object group of audio objects,
wherein the processor unit is configured not to apply the at least one effect parameter specified by means of the interface to any position of the audio object metadata of the one or more audio objects of the plurality of audio objects that do not belong to the processing-object group of audio objects.

6. Device as claimed in claim 1,
wherein the interface is configured to specify at least one definition parameter of the processing-object group of audio objects by the user,
wherein the processor unit is configured to determine, in dependence on the at least one definition parameter of the processing-object group of audio objects specified by means of the interface, which audio objects of the plurality of audio objects belong to the processing-object group of audio objects.

7. Device as claimed in claim 6,
wherein the at least one definition parameter of the processing-object group of audio objects comprises at least one position of a area of interest associated with the processing-object group of audio objects, and
wherein the processor unit is configured to determine, depending on the position of the audio object metadata of that audio object and depending on the position of the area of interest, for each audio object of the plurality of audio objects whether said audio object belongs to the processing-object group of audio objects,

8. Device as claimed in claim 7,
wherein the at least one definition parameter of the processing-object group of audio objects further comprises a radius of the area of interest that is associated with the processing-object group of audio objects, and
wherein the processor unit is configured to decide, for each audio object of the plurality of audio objects, depending on the position of the audio object metadata of that audio object and depending on the position of the area of interest and depending on the radius of the area of interest, whether that audio object belongs to the processing-object group of audio objects.

9. Device as claimed in claim 7,
wherein the processor unit is configured to determine a weighting factor for each of the audio objects of the processing-object group of audio objects depending on a distance between the position of the audio object metadata of that audio object and the position of the area of interest, and
wherein the processor unit is configured to apply, for each of the audio objects of the processing-object group of audio objects, the weighting factor of this audio object together with the at least one effect parameter specified by means of the interface to the audio object signal or to the gain parameter of the audio object metadata of this audio object.

10. Device as claimed in claim 6,
wherein the at least one definition parameter of the processing-object group of audio objects comprises at least one angle specifying a direction from a defined user position in which there is an area of interest associated with the processing-object group of audio objects, and
wherein the processor unit is configured to determine, depending on the position of the metadata of the audio object and depending on the angle specifying the direction from the defined user position in which the area of interest is located, for each audio object of the plurality of audio objects, whether the audio object belongs to the processing-object group of audio objects, depending on the position of the metadata of the audio object and depending on the angle specifying the direction from the defined user position in which the area of interest is located.

11. Device as claimed in claim 10,
wherein the processor unit is configured to determine for each of the audio objects of the processing-object group of audio objects, a weighting factor which depends on a difference of a first angle and a further angle, wherein the first angle is the angle specifying the direction from the defined user position in which the area of interest is located, and wherein the further angle depends on the defined user position and on the position of the metadata of this audio object,
wherein the processor unit is configured to apply, for each of the audio objects of the processing-object group of audio objects, the weighting factor of this audio object together with the at least one effect parameter specified by means of the interface to the audio object signal or to the gain parameter of the audio object metadata of this audio object.

12. Device as claimed in claim 1,
wherein the processing-object group of audio objects is a first processing-object group of audio objects, wherein there also exist one or more further processing-object groups of audio objects, wherein each processing-object group of the one or more further processing-object groups of audio objects comprises one or more audio objects of the plurality of audio objects, wherein at least one audio object of a processing-object group of the one or more further processing-object groups of audio objects is not an audio object of the first processing-object group of audio objects,
wherein the interface is configured, for each processing-object group of the one or more further processing-object groups of audio objects, for specification of at least one further effect parameter for that processing-object group of audio objects on the part of the user,
wherein the processor unit is configured to generate the processed signal such that for each processing-object group of the one or more further processing-object groups of audio objects, the at least one further effect parameter of this processing-object group that was specified by means of the interface is applied to the audio object signal or to the audio object metadata of each of the one or more audio objects of this processing-object group, wherein one or more audio objects of the plurality of audio objects do not belong to this processing-object group, and wherein the processor unit is configured not to apply the at least one further effect parameter of this processing-object group specified by means of the interface to any audio object signal and any audio object metadata of the one or more audio objects which do not belong to this processing-object group.

13. Device as claimed in claim 12,
wherein the interface is configured, in addition to the first processing-object group of audio objects, for specification of the one or more further processing-object groups of one or more audio objects on the part of the user, in that the interface is configured, for each processing-object group of the one or more further processing-object groups of one or more audio objects, for specification of at least one definition parameter of that processing-object group on the part of the user,
wherein the processor unit is configured to determine for each processing-object group of the one or more further processing-object groups of one or more audio objects, in dependence on the at least one definition parameter of this processing-object group specified by means of the interface, which audio objects belong to the plurality of audio objects of this processing-object group.

14. Device as claimed in claim 1,
the device being an encoder, wherein the processor unit is configured to generate a downmix signal while using the audio object signals of the plurality of audio objects, and wherein the processor unit is configured to generate a metadata signal while using the audio object metadata of the plurality of audio objects,
wherein the processor unit is configured to generate the downmix signal as the processed signal, at least one modified object signal being mixed, in the downmix signal, for each audio object of the processing-object group of audio objects, the processor unit being configured to generate, for each audio object of the processing-object group of audio objects, the modified object signal of this audio object by applying the at least one effect parameter specified by means of the interface to the audio object signal of this audio object, or
wherein the processor unit is configured to generate the metadata signal as the processed signal, the metadata signal comprising at least one modified position for each audio object of the processing-object group of audio objects, wherein the processor unit is configured to generate, for each audio object of the processing-object group of audio objects, the modified position of this audio object by applying the at least one effect parameter specified by means of the interface to the position of this audio object, or
the processor unit is configured to generate the metadata signal as the processed signal, the metadata signal comprising at least one modified gain parameter for each audio object of the processing-object group of audio objects, the processor unit is configured to generate, for each audio object of the processing-object group of audio objects, the modified gain parameter of this audio object by applying the at least one effect parameter specified by means of the interface to the gain parameter of this audio object.

15. Device as claimed in claim 1,
the device being a decoder, the device being configured to receive a downmix signal in which the plurality of audio object signals of the plurality of audio objects are mixed, the device further being configured to receive a metadata signal, the metadata signal comprising, for each audio object of the plurality of audio objects, the audio object metadata of that audio object,
wherein the processor unit is configured to reconstruct the plurality of audio object signals of the plurality of audio objects on the basis of a downmix signal,
wherein the processor unit is configured to generate, as the processed signal, an audio output signal comprising one or more audio output channels,
wherein the processor unit is configured to apply the at least one effect parameter specified by means of the interface to the audio object signal of each of the audio objects of the processing-object group of audio objects to generate the processed signal, or to apply the at least one effect parameter specified by means of the interface to the position or to the gain parameter of the audio object metadata of each of the audio objects of the processing-object group of audio objects to generate the processed signal.

16. Device as claimed in claim 15,
wherein the interface is further adapted for specification of one or more rendering parameters on the part of the user,
and wherein the processor unit is configured to generate the processed signal while using the one or more rendering parameters as a function of the position of each audio object of the processing-object group of audio objects.

17. System comprising
an encoder for generating a downmix signal on the basis of audio object signals of a plurality of audio objects and for generating a metadata signal on the basis of audio object metadata of the plurality of audio objects, wherein the audio object metadata comprises a position of the audio object and a gain parameter of the audio object, and
a decoder for generating an audio output signal comprising one or more audio output channels on the basis of the downmix signal and on the basis of the metadata signal,
wherein the encoder is a device wherein the processor unit is configured to generate a downmix signal while using the audio object signals of the plurality of audio objects, and wherein the processor unit is configured to generate a metadata signal while using the audio object metadata of the plurality of audio objects,
wherein the processor unit is configured to generate the downmix signal as the processed signal, at least one modified object signal being mixed, in the downmix signal, for each audio object of the processing-object group of audio objects, the processor unit being configured to generate, for each audio object of the processing-object group of audio objects, the modified object signal of this audio object by applying the at least one effect parameter specified by means of the interface to the audio object signal of this audio object, or
wherein the processor unit is configured to generate the metadata signal as the processed signal, the metadata signal comprising at least one modified position for each audio object of the processing-object group of audio objects, wherein the processor unit is configured to generate, for each audio object of the processing-object group of audio objects, the modified position of this audio object by applying the at least one effect parameter specified by means of the interface to the position of this audio object, or
the processor unit is configured to generate the metadata signal as the processed signal, the metadata signal comprising at least one modified gain parameter for each audio object of the processing-object group of audio objects, the processor unit is configured to generate, for each audio object of the processing-object group of audio objects, the modified gain parameter of this audio object by applying the at least one effect parameter specified by means of the interface to the gain parameter of this audio object,
or
wherein the decoder is a device configured to receive a downmix signal in which the plurality of audio object signals of the plurality of audio objects are mixed, the device further being configured to receive a metadata signal, the metadata signal comprising, for each audio object of the plurality of audio objects, the audio object metadata of that audio object,
wherein the processor unit is configured to reconstruct the plurality of audio object signals of the plurality of audio objects on the basis of a downmix signal,
wherein the processor unit is configured to generate, as the processed signal, an audio output signal comprising one or more audio output channels,
wherein the processor unit is configured to apply the at least one effect parameter specified by means of the interface to the audio object signal of each of the audio objects of the processing-object group of audio objects to generate the processed signal, or to apply the at least one effect parameter specified by means of the interface to the position or to the gain parameter of the audio object metadata of each of the audio objects of the processing-object group of audio objects to generate the processed signal,
or
wherein the encoder is a device as claimed in claim 14 and the decoder is a device as claimed in claim 15.

18. Method of generating a processed signal while using a plurality of audio objects, each audio object of the plurality of audio objects comprising an audio object signal and audio object metadata, the audio object metadata comprising a position of the audio object and a gain parameter of the audio object, the method comprising:
specifying at least one effect parameter of a processing-object group of audio objects on the part of a user by means of an interface, wherein the processing-object group of audio objects comprises two or more audio objects of the plurality of audio objects, and
generating the processed signal by a processor unit such that the at least one effect parameter specified by means of the interface is applied to the audio object signal or to the audio object metadata of each of the audio objects of the processing-object group of audio objects.

19. A non-transitory digital storage medium having a computer program stored thereon to perform the method of generating a processed signal while using a plurality of audio objects, each audio object of the plurality of audio objects comprising an audio object signal and audio object metadata, the audio object metadata comprising a position of the audio object and a gain parameter of the audio object, said method comprising:
specifying at least one effect parameter of a processing-object group of audio objects on the part of a user by means of an interface, wherein the processing-object group of audio objects comprises two or more audio objects of the plurality of audio objects, and
generating the processed signal by a processor unit such that the at least one effect parameter specified by means of the interface is applied to the audio object signal or to the audio object metadata of each of the audio objects of the processing-object group of audio objects,
when said computer program is run by a computer.
